(19) United States
(12) Patent Application Publication
(10) Pub. No.: US 2013/0339666 A1
(43) Pub. Date: Dec. 19, 2013

(54) SPECIAL CASE REGISTER UPDATE WITHOUT EXECUTION

(71) Applicants: Gregory W. Alexander, Pflugerville, TX (US); Brian D. Barrick, Pflugerville, TX (US); Fadi Y. Busaba, Poughkeepsie, NY (US); Bruce C. Giamei, Poughkeepsie, NY (US); Edward T. Malley, New Rochelle, NY (US); Chung-Lung K. Shum, Wappingers Falls, NY (US)

(72) Inventors: Gregory W. Alexander, Pflugerville, TX (US); Brian D. Barrick, Pflugerville, TX (US); Fadi Y. Busaba, Poughkeepsie, NY (US); Bruce C. Giamei, Poughkeepsie, NY (US); Edward T. Malley, New Rochelle, NY (US); Chung-Lung K. Shum, Wappingers Falls, NY (US)

(73) Assignee: INTERNATIONAL BUSINESS MACHINES CORPORATION, Armonk, NY (US)

(21) Appl. No.: 13/524,471

(22) Filed: Jun. 15, 2012

(51) Int. Cl. G06F 9/30

(52) U.S. Cl. 712/208; 712/E09.028

(57) ABSTRACT

A method of changing a value of associated with a logical address in a computing device. The method includes: receiving an instruction at an instruction decoder, the instruction including a target register expressed as a logical value; determining at an instruction decoder that a result of the instruction is to set the target register to a constant value, the target register being in a physical register file associated with an execution unit; and mapping, in a register mapper, the logical address to a location represented by a special register tag.

### BACKGROUND

The present invention relates generally to updating registers and, more specifically, to process updating registers used by an execution unit without requiring processing by the execution unit.

Processing in modern computers involves, at its root, the manipulation of data by an execution unit. The execution unit can have specifically assigned registers from which it can receive operands (sources) for manipulation and into which it can store the results (targets) of the manipulation. For instance, suppose that the execution unit needs to add two values together to create a result. Symbolically, that manipulation could take the form {A=B+C}. In order to operate correctly, the values of B and C need to be brought into the execution unit from the registers assigned to the execution unit. In addition, the execution unit needs to know where to store the result. For each of these to happen, a map of registers is used to covert from a logical address (e.g., A, B, C) to a physical address that identifies one of the registers.

While memory has become much smaller and cheaper in computing system, there are still limitations on the amount of memory (e.g. the size of a register file) that can be assigned to a particular functional unit. That is, there is typically a small number of registers assigned to a particular execution unit. Thus, it is important that these registers be used efficiently.

### SUMMARY

One embodiment is directed to a computer program product for changing a value of associated with a logical address in a computing device including an instruction decoder, a register mapper, an execution unit and a physical register file associated with the execution unit. The computer program product includes a tangible storage medium readable by a processing circuit and storing instructions for execution by the processing circuit for performing a method. The method includes: receiving an instruction at an instruction decoder, the instruction including a target register expressed as a logical value; determining at an instruction decoder that a result of the instruction is to set the target register to a constant value, the target register being in a physical register file associated with an execution unit; and mapping, in a register mapper, the logical address to a location represented by a special register tag.

Another embodiment is directed to a method of changing a value of associated with a logical address in a computing device including an instruction decoder, a register mapper, an execution unit and a physical register file associated with the execution unit. The method of this embodiment includes: receiving an instruction at an instruction decoder, the instruction including a target register expressed as a logical value; determining at an instruction decoder that a result of the instruction is to set the target register to a constant value, the target register being in a physical register file associated with an execution unit; and mapping, in a register mapper, the logical address to a location represented by a special register tag.

Another embodiment is directed to a system that includes an execution unit and a physical register file associated with the execution unit. The system also includes an instruction decoder that receives an instruction. The instruction includes a target register expressed as a logical value and the instruction decoder includes logic configured to determine that a result of the instruction is to set the target register to a constant value. The system also includes a register mapper that maps the target register to a location represented by a special register tag.

Additional features and advantages are realized through the techniques of the present disclosure. Other embodiments and aspects are described in detail herein and are considered a part of the claimed invention. For a better understanding of the disclosure with advantages and features, refer to the description and to the drawings.

### BRIEF DESCRIPTION OF THE SEVERAL VIEWS OF THE DRAWINGS

The subject matter which is regarded as embodiments is particularly pointed out and distinctly claimed in the claims at the conclusion of the specification. The forgoing and other features, and advantages of the embodiments are apparent from the following detailed description taken in conjunction with the accompanying drawings in which:

FIG. 1 depicts a functional block diagram of system according to one embodiment;

FIG. 2 depicts a flow chart according to one embodiment;

FIG. 3 depicts a function block diagram of a physical register file according to one embodiment;

FIG. 4 depicts a flow chart according to one embodiment; and

FIG. 5 depicts a computer program product in accordance with an embodiment.

### DETAILED DESCRIPTION

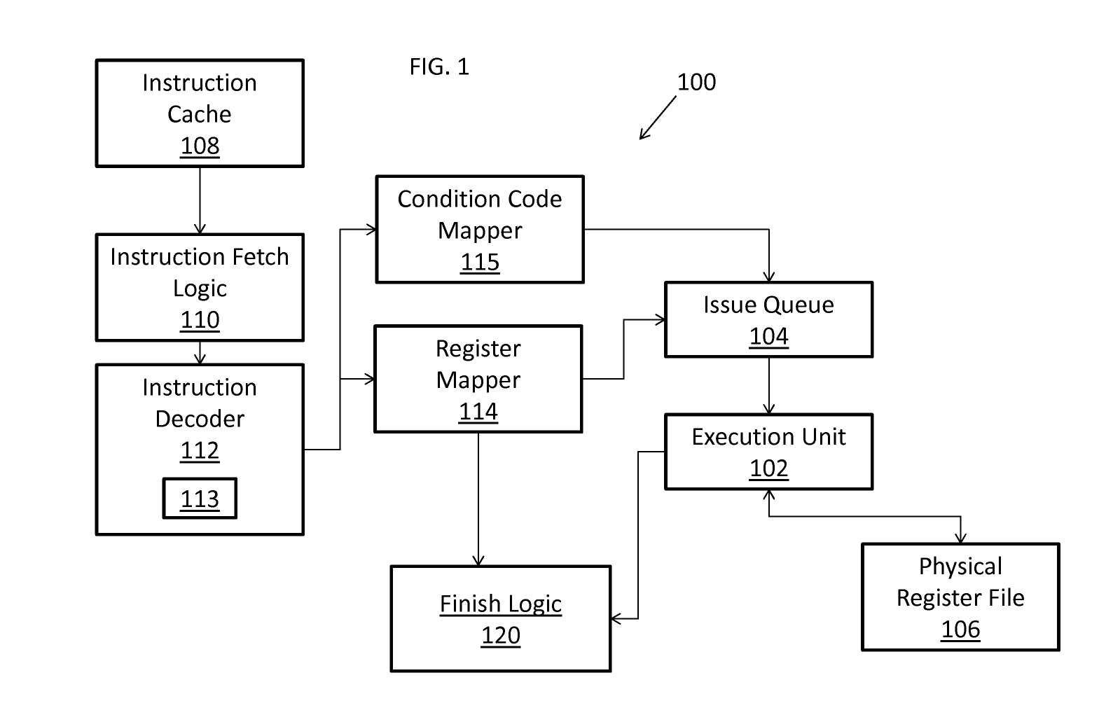

Referring now to FIG. 1, a dataflow diagram of a system 100 in which embodiments disclosed herein may be implemented, is illustrated. The system 100 could be part of, for example, a central processing unit of a computing device. According to embodiments disclosed herein, a method/system is described that can provide for updating of registers without operation of the execution unit 102. In the embodiment shown in FIG. 1, the system 100 includes finish logic 120 that deals with completed instructions as shall be understood by the skilled artisan and is entered when an instruction is completed. As will be further described below, operating in accordance with one or more embodiments disclosed herein can allow for the updating of register values in specific cases without requiring processing by either the issue queue 104 or the execution unit 102. As such, processing speed of the system 100 may be improved because other instruction will be allowed access to the issue queue 104 and the execution unit 102 sooner. Further, embodiments disclosed herein may also allow for improved usage of the physical register file 106 assigned to the execution unit 102.

The operation of the system 100 will first be described in the context of conventional operation and then differences between the system 100 according to embodiments disclosed herein and the conventional operation will be described. The system 100 includes an instruction cache 108 that stores one or more instructions that, ultimately, will be performed by the execution unit 102. The system 100 also includes instruction fetch logic 110 that is configured to retrieve an instruction out of instruction cache 108. The instruction is provided to instruction decoder 112 by the instruction fetch logic 110. The instruction fetch logic 110 may also provide an instruction to the instruction decoder 112. As illustrated, the instruction decoder 112 includes a special case sub-block 113 that is described in greater detail below.

The instruction decoder 112 is configured to determine what “action” is to be taken by the execution unit 102 in order to satisfy the instruction. The instruction decoder 112 is also configured to determine the logical resources (also referred to as “logical addresses” herein) that will need to be used by the execution unit 102.

Consider for example the instruction XR R1, R1. In this case, a logical address (R1) is being exclusively “ORd” with itself. The result of such an operation results in R1 being set to zero, and a condition code value of zero. In this case, the source (logical address R1) and the target (again, R1) are provided to a register mapper 114. The register mapper 114 converts the logical addresses into physical (PREG) address used to address a particular location in the physical register file 106, and maps the condition code result of the instruction if required to a new register location. In addition, the register mapper 114 assigns a location for the target (this target location may the same or different than the source location depending on how the register mapper is configured). It shall be understood that the operations of the register mapper 114 can include dynamically assigning, committing, and retiring mappings as will be understood by those skilled in the art.

The information from the instruction decode 112 along with the mapped physical addresses in the physical register file 106 are then provided to the issue queue 104 for execution. The issue queue 104 may need to resolve any dependencies (out of order design) and, as such, the system may also include a condition code mapper 115. The operation of the condition code mapper 115 is within the understanding of the skilled artisan and not disclosed further. After dependencies (if they exist) are resolved, the issue queue 104 provides the action and the physical addresses of the source and target to the execution unit 102. The execution unit 102 then provides the physical address for R1 to the physical register file 106 which returns the value stored in that location to the execution unit 102. The execution unit 102 then performs the operation and writes the result back to the target location. and updates the condition code when required.

As shall be apparent from the above, normal updates to a logical register location (identified by instruction) will generate a new mapping into the physical register file 106, occupy an issue queue 104 location, send a request to the execution unit 102 and finally write the result of the execution back into the physical register file 106.

There are some cases where it can be determined from the instruction (e.g., by the special case sub-block 113 of the instruction decoder 112) itself that the result of the operation is simply to write a constant (e.g., “0”) to the result location. In such cases, according one embodiment, rather than update the physical register file 106, the mapping for the particular logical address (e.g., for R1 in the above example) is changed in the register mapper 114 such that it maps to a specific location in the physical register file 106 that has the value of the constant stored therein. In such cases, usage of the issue queue 104 and the execution unit 102 can be reduced and, thereby, performance of the system 100 can be increased. The determination that the constant is being assigned to a logical address can be determined by the special case sub block 113. The sub block 113 could recognize, for example, write immediate type instructions (e.g., load half immediate (32 bit register) {LHI R1, Immediate}, load half immediate (64 bit register) {LGHI R1, Immediate} where a typical immediate value considered is less than 15), instances where a value is XOR'd with itself (e.g., {XR, R1, R1} or {XGR R1, R1} Other examples include, for instance, a load address instruction of the form {LA R1, D2(B2, X2) where B2=X2=0 and displacement value (D2) is the constant with a typical value considered less than 15 (LA R1, D2(B2,X2)). In the load address (LA) instruction, the register R1 is loaded from the addition of the base register (B2) to index register (X2) to the displacement. If the register number for B2 and X2 is zero, then zeros are added instead of the contents of the register 0. Other instructions include a set of subtract instructions with equal operands (e.g. SR R1,R2 or SGR R1,R2) and a set of load immediate instructions

An example is illustrative. Consider again the case where the instruction is {XR, R1, R1}. The result of this operation is, quite simply, to assign the value “0” to the all bits of R1 and to set the condition code to zero. In operating the system as described above, the execution unit 102 would have to retrieve the R1 from the physical register file 106, perform the XOR function and write the result (all 0's) to the target destination. In contrast, in one embodiment, suppose that a particular one of the registers in the physical register file 106 is assigned to the value “0” and cannot be changed. Every time a logical address (e.g., R1, R2, etc.) is assigned to “0”, this could be represented by simply changing the mapping for that logical address in the address mapper 114 to point to the particular register in the physical register file 106 that contains all 0's. In such cases, all such logical addresses can be set to zero but no writes to the physical register file 106 were performed to achieve this. In addition, because multiple logical addresses are mapped to the particular location, space is freed up in the physical register file 106 and, as such, it can be used to hold more data than if it has to store separate “0” data values for each of the logical addresses assigned to zero. When register R1 is used as one of the operands for subsequent instructions, processing occurs in the normal manner and the value of “0” is retrieved from the particular location to which the logical address of the source is mapped. This embodiment could be extended to early mapping of target values other than just “0”. In such a case, the physical register file 106 could include several dedicated registers, each assigned to a different constant.

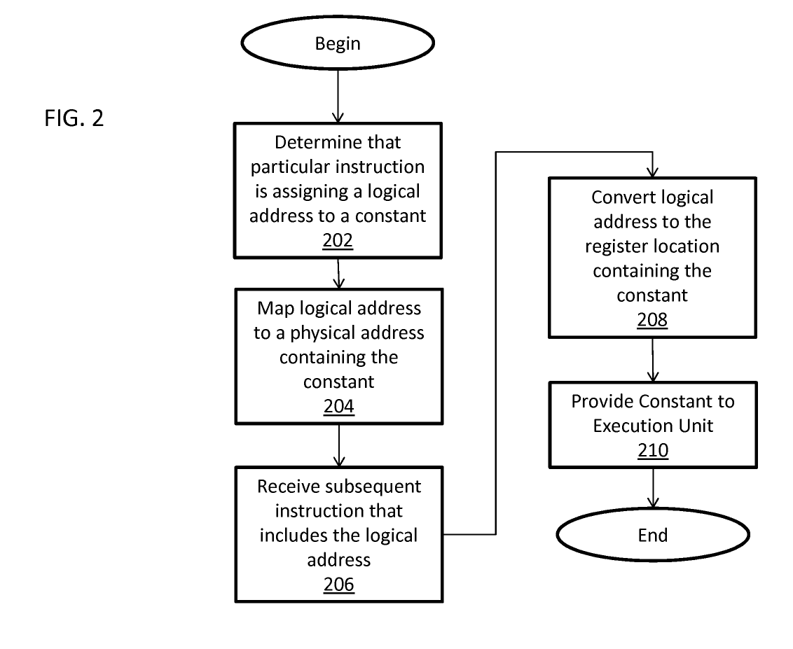

FIG. 2 is flow chart illustrating a method according to the embodiment just described. At block 202 the instruction decoder 112 generally (and the special case sub block 113 in particular) determines that a particular instruction is merely assigning a particular logical address to a constant. This could be accomplished, for example, by having a listing of conditions that have such a result. A partial list of such conditions is given above but one of ordinary skill will realize that other conditions could have the same result.

At block 204, the register mapper 114 maps the logical address (e.g., R1) to the physical register location in the physical register file 106 that has been assigned to the constant value. Such an assignment shall be referred to as a “special register tag” herein. Of course, as shown below, a special register tag can also refer to an address not contained in the physical register file 106.

At block 206 a subsequent instruction is received that includes the logical address that includes a special register tag (e.g., R1 in the above example). The logical address is converted by the register mapper 114 at block 208 into a source address identifying the location in the physical register file 106 that includes the constant (e.g., 0) that was the result of the instruction described above. The constant value stored in that location is then provide to the execution unit 102 by the physical register file 106 at block 210.

Another embodiment can achieve substantially same result without requiring that any registers in the physical register file are actually assigned to a particular value. In such a case, the register mapper 114 assigns a special mapping to a location that is not in the physical register file 106. As mentioned above, such a special mapping is also referred to herein as a special register tag. In such a case, the special register tag may actually be a data value.

Referring again to FIG. 1, in this embodiment, the special case sub block 113 of the instruction decoder 112 determines that the result of the operation is write a constant to the particular target (e.g. an instruction such as {XR R1, R1}). Such a determination is provided to the register mapper 114 which then assigns a special register tag to the target (X1). In this embodiment, the special register tag can be the constant itself (e.g. “0”) or it can be address, not in the physical register file 106 from which the constant can be determined. When the target is later a source address, the mapper 114 provides the special register tag instead of a pointer to a location in the physical register file.

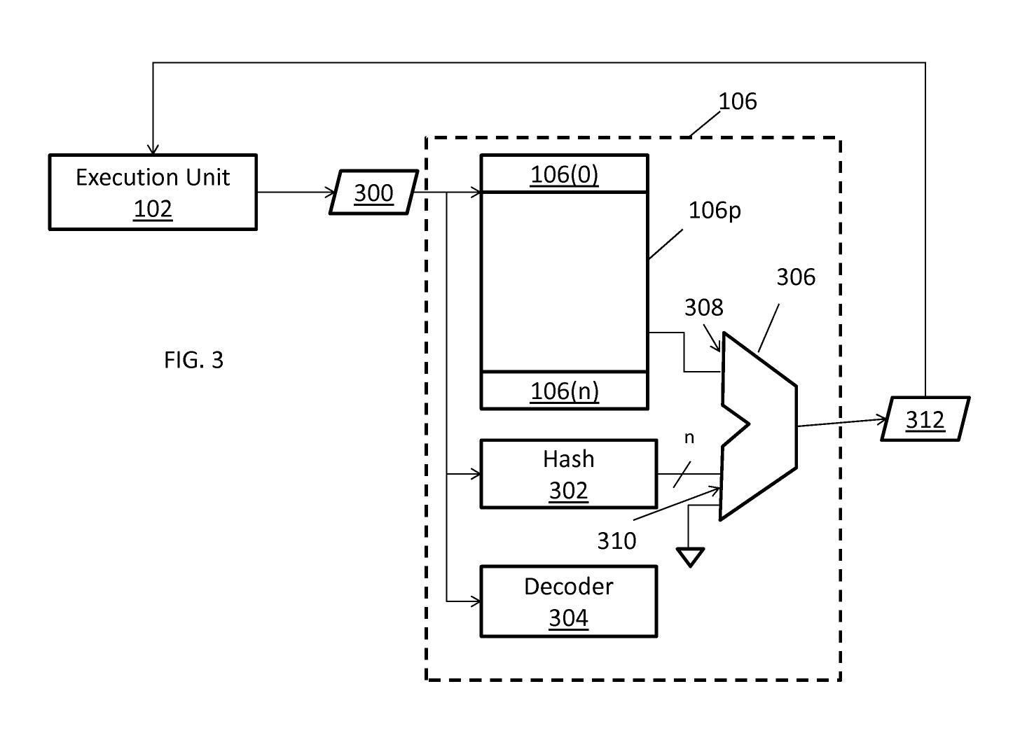

FIG. 3 is a logical representation of one example of how a system can operate with special register tags that are either a constant value or are expressed as an address not in the physical register file 106. In FIG. 3, the actual registers in the physical register file 106 are shown by reference numeral 106p. The actual registers 106p can include from 1 to n entries (expressed as entries 106(0) to 106(n) in FIG. 3). While not by way of limitation but merely for illustrative purposes, in the following description it shall be assumed that the logical register file 106 includes 80 entries (e.g., 106(0) to 106(79)). In this example, assume that the special register tag is equal to the number of entries in the actual registers 106p (80) plus the specific constant. Thus, for example, if the constant is “0”, the special register tag will have a value of 80; if it the constant is “5”, the special register tag will have a value of 85.

In this example, the register file 106 is shown as including a hash function 302, a decoder 304 and an output selector 306 implemented as a multiplexer. In FIG. 3, the output selector 306 includes a first input 308 and a second input 310 and provides an output 312 that is provided to the execution unit 102. Upon execution, the execution unit 102 will provide the source address 300 to the register file 106 where it is received by the decoder 304, the actual registers 106p and the hash function 302. If the source address 300 is in the range of the actual registers, the value in the particular register is provided to the output selector 306. If it is not, no value, zeros, or some other value could be provided. Regardless, the source address is also processed by the hash function 302 to provide an input to the output selector 306. In one embodiment, the hash selector 302 is formed such that it masks out all but a certain number n (e.g. 4) of the low order bits of the address. This could be accomplished, for example, by simply connecting the lowest order bits of the lines carrying the address 300 (assuming a parallel bus) as the lower order bits of one of the selectable inputs to the output selector 306 tying all other bits of that input to zero as shown in FIG. 3. The decoder determines if the address is special (e.g., 80 or greater) on not and, based on this determination, causes the output selector to provide either the register value or the hashed value.

Consider this case where the source address 300 has a value of 85. In such a case, the low order bits 310a, 310b, 310c and 310d of the second input 310 will be 0101 (the leading bits will all be 0). The decoder 304 will determine that this address is a special register tag (e.g. its value is 80 or greater) and cause the output selector 306 to pass the second input 310 as the output 312. If on the other hand the source address 300 was less than 80, the appropriate actual register (e.g., one of 106(0) . . . 106(n) is provided to the output selector 306 and passed as the output 312.

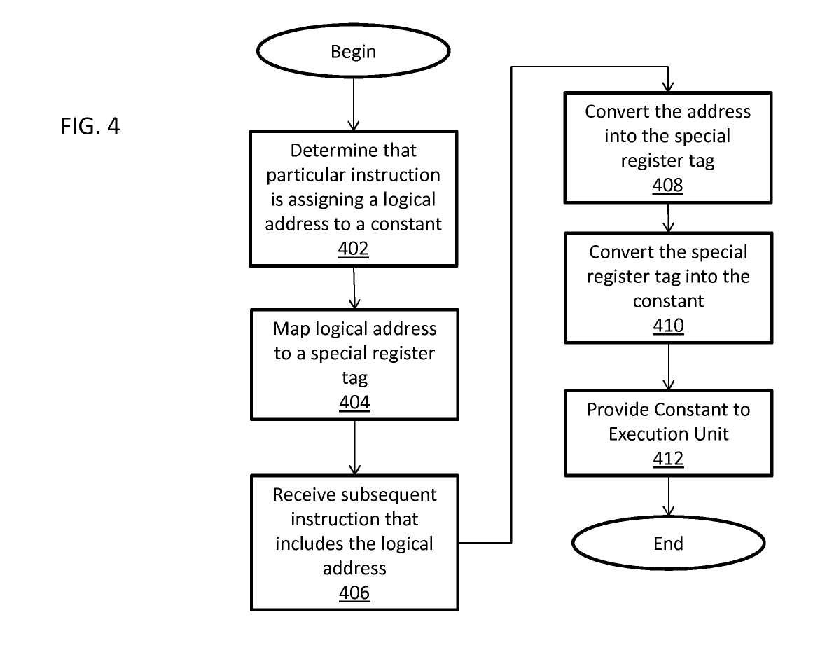

FIG. 4 is flow chart illustrating a method according to the embodiment just described. At block 402 the instruction decoder 112 generally (and the special case sub block 113 in particular) determines that a particular instruction is merely assigning a particular logical address to a constant. This could be accomplished, for example, by having a listing of conditions that have such a result. A partial list of such conditions is given above but one or ordinary skill will realize that other conditions could have the same result.

At block 404, the register mapper 114 maps the logical address (e.g., R1) to either a constant value or location that is not contained in the actual registers 106p. Of course, the value could be a value from which the constant could be derived and also not be contained in the actual registers. As discussed above, any of these types of mappings can be referred to as a “special register tag” herein.

At block 406 a subsequent instruction is received that includes the logical address that includes a special register tag (e.g., R1 in the above example). The logical address is converted by the register mapper 114 at block 408 into the special register tag. At block 410, the special register tag is converted into the constant value. As described above, the special register tag can be converted into the constant value by selecting the low order bits of the special register tag. The constant value stored in that location is then provide to the execution unit 102 by the physical register file 106 at block 412.

As will be appreciated by one skilled in the art, one or more aspects of the present invention may be embodied as a system, method or computer program product. Accordingly, one or more aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system”. Furthermore, one or more aspects of the present invention may take the form of a computer program product embodied in one or more computer readable medium(s) having computer readable program code embodied thereon.

Any combination of one or more computer readable medium(s) may be utilized. The computer readable medium may be a computer readable storage medium. A computer readable storage medium may be, for example, but not limited to, an electronic, magnetic, optical, electromagnetic, infrared or semiconductor system, apparatus, or device, or any suitable combination of the foregoing. More specific examples (a non-exhaustive list) of the computer readable storage medium include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

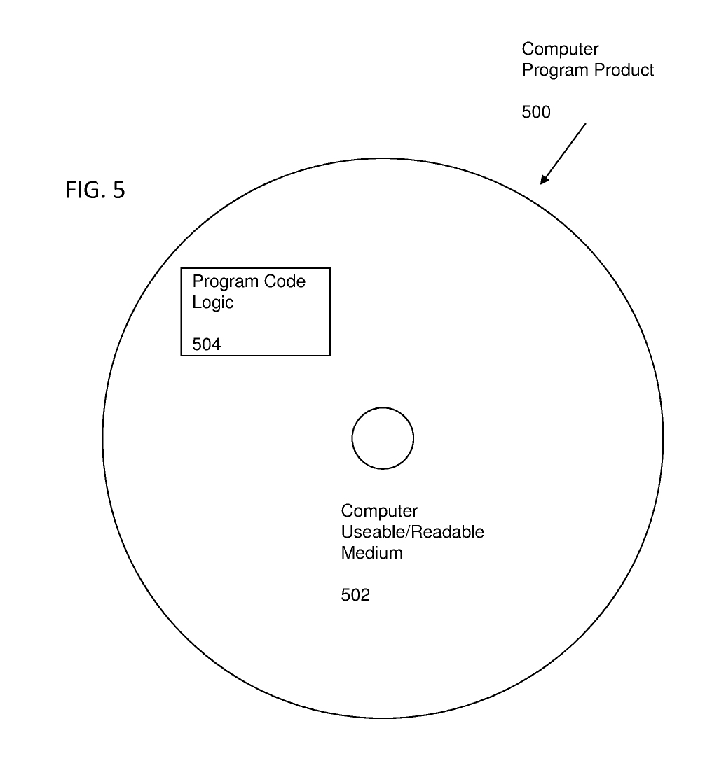

Referring now to FIG. 5, in one example, a computer program product 500 includes, for instance, one or more storage media 502, wherein the media may be tangible and/or non-transitory, to store computer readable program code means or logic 504 thereon to provide and facilitate one or more aspects of embodiments described herein.

Program code, when created and stored on a tangible medium (including but not limited to electronic memory modules (RAM), flash memory, Compact Discs (CDs), DVDs, Magnetic Tape and the like is often referred to as a “computer program product”. The computer program product medium is typically readable by a processing circuit preferably in a computer system for execution by the processing circuit. Such program code may be created using a compiler or assembler for example, to assemble instructions, that, when executed perform aspects of the invention.

One embodiment is directed to a computer program product for changing a value of associated with a logical address in a computing device including an instruction decoder, a register mapper, an execution unit and a physical register file associated with the execution unit. The computer program product includes a tangible storage medium readable by a processing circuit and storing instructions for execution by the processing circuit for performing a method. The method includes: receiving an instruction at an instruction decoder, the instruction including a target register expressed as a logical value; determining at an instruction decoder that a result of the instruction is to set the target register to a constant value, the target register being in a physical register file associated with an execution unit; and mapping, in a register mapper, the logical address to a location represented by a special register tag.

In one embodiment, the computer program product also includes instructions that cause the method to further include assigning one or more of the registers in the physical register file an unchangeable constant value. In this embodiment, the special register tag is equal to an address of the register in the physical register file having an unchangeable constant value equal to the constant value.

In one embodiment, the location represented by the special register tag is not contained in the physical register file.

In one embodiment of the computer program product, the special register tag is equal to or can be converted to the constant value.

In one embodiment, the computer program product also includes instructions that cause the method to further include: receiving an instruction that requires retrieving a value from the target register; converting the special register tag to the constant value utilizing a hash function; and providing the constant value to the execution unit.

In one embodiment of the computer program product, the special register tag is assigned independent of the execution unit.

In one embodiment of the computer program product, the system further includes an issue queue and the special register tag is assigned independent of the issue queue.

Another embodiment is directed to a method of changing a value of associated with a logical address in a computing device including an instruction decoder, a register mapper, an execution unit and a physical register file associated with the execution unit. The method of this embodiment includes: receiving an instruction at an instruction decoder, the instruction including a target register expressed as a logical value; determining at an instruction decoder that a result of the instruction is to set the target register to a constant value, the target register being in a physical register file associated with an execution unit; and mapping, in a register mapper, the logical address to a location represented by a special register tag.

In one embodiment the method further includes assigning one or more of the registers in the physical register file an unchangeable constant value. In this embodiment, the special register tag is equal to an address of the register in the physical register file having an unchangeable constant value equal to the constant value.

In one embodiment of the method, the location represented by the special register tag is not contained in the physical register file.

In one embodiment of the method, the special register tag is equal to or can be converted to the constant value.

In one embodiment of the method, the method further includes receiving an instruction that requires retrieving a value from the target register; converting the special register tag to the constant value utilizing a hash function; and providing the constant value to the execution unit.

In one embodiment of the method, the special register tag is assigned independent of the execution unit.

In one embodiment of the method, the system further includes an issue queue and the special register tag is assigned independent of the issue queue.

Another embodiment is directed to a system that includes an execution unit and a physical register file associated with the execution unit. The system also includes an instruction decoder that receives an instruction. The instruction includes a target register expressed as a logical value and the instruction decoder includes logic configured to determine that a result of the instruction is to set the target register to a constant value. The system also includes a register mapper that maps the target register to a location represented by a special register tag.

In one embodiment of the system, one or more of the registers in the physical register file is assigned to an unchangeable constant value and the special register tag points to the register in the physical register file having an unchangeable constant value equal to the constant value.

In one embodiment of the system, the special register tag points to an address not contained in the physical register file.

In one embodiment of the system, the special register tag is equal to or can be converted to the constant value.

In one embodiment of the system, the physical register file is further configured to convert the special register tag to the constant value utilizing a hash function and provide the constant value to the execution unit when another instruction that includes the target register is received by the instruction decoder.

Technical effects and benefits include reducing the number of execution unit operations required for setting a logical value to a constant.

The terminology used herein is for the purpose of describing particular embodiments only and is not intended to be limiting of embodiments. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of embodiments have been presented for purposes of illustration and description, but is not intended to be exhaustive or limited to the embodiments in the form disclosed. Many modifications and variations will be apparent to those of ordinary skill in the art without departing from the scope and spirit of the embodiments. The embodiments were chosen and described in order to best explain the principles and the practical application, and to enable others of ordinary skill in the art to understand the embodiments with various modifications as are suited to the particular use contemplated.

Computer program code for carrying out operations for aspects of the embodiments may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of embodiments are described above with reference to flowchart illustrations and/or schematic diagrams of methods, apparatus (systems) and computer program products according to embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

1.-14. (canceled)

15. A system comprising:
an execution unit;
a physical register file associated with the execution unit;
an instruction decoder that receives an instruction, the instruction including a target register expressed as a logical value, the instruction decoder including logic configured to determine that a result of the instruction is to set the target register to a constant value; and
a register mapper that maps the target register to a location represented by a special register tag.

16. The system of claim 15, wherein one or more of the registers in the physical register file is assigned to an unchangeable constant value and wherein the special register tag points to the register in the physical register file having an unchangeable constant value equal to the constant value.

17. The system of claim 15, wherein the special register tag points to an address not contained in the physical register file.

18. The system of claim 17, wherein the special register tag is equal to or can be converted to the constant value.

19. The system of claim 18, wherein the physical register file is further configured to convert the special register tag to the constant value utilizing a hash function and provides the constant value to the execution unit when another instruction that includes the target register is received by the instruction decoder.
